(19) United States
(12) Patent Application Publication
(10) Pub. No.: US 2024/0430926 A1
(43) Pub. Date: Dec. 26, 2024

(54) METHOD OF RECEIVING PHYSICAL DOWNLINK CONTROL CHANNEL AND THE CORRESPONDING EQUIPMENT

(71) Applicant: SAMSUNG ELECTRONICS CO., LTD., Suwon-si (KR)

(72) Inventors: Yi WANG, Beijing (CN); Feifei SUN, Beijing (CN)

(21) Appl. No.: 18/823,537

(22) Filed: Sep. 3, 2024

Related U.S. Application Data
(63) Continuation of application No. 17/699,046, filed on Mar. 18, 2022.

(30) Foreign Application Priority Data
Mar. 22, 2021 (CN) 202110304384.6

(51) Int. Cl. H04W 72/56; H04L 1/00; H04W 24/08; H04W 72/0446; H04W 72/23

(52) U.S. Cl. CPC H04W 72/56; H04L 1/0038; H04W 24/08; H04W 72/0446; H04W 72/23

(57) ABSTRACT

The disclosure relates to a 5G or 6G communication system for supporting a higher data transmission rate. The application discloses a method of receiving physical downlink control channel and corresponding equipment. According to an aspect of the application, there is provided a method performed by user equipment (UE) in a communication system, including: receiving, by the UE, time resource information of a search space configured by a base station; determining, by the UE, the time resource position of the search space according to the time resource information of the search space configured by the base station; determining, by the UE, the times of blind detection for a physical downlink control channel (PDCCH)/a number of non-overlapping control channel elements (CCE) in the search space.

### CROSS-REFERENCE TO RELATED APPLICATION

This application is a continuation of application Ser. No. 17/699,046 filed Mar. 18, 2022, which is based on and claims priority under 35 U.S.C. § 119 to Chinese Patent Application No. 202110304384.6, filed Mar. 22, 2021, in the China National Intellectual Property Office, the disclosure of which is incorporated by reference herein in its entirety.

### BACKGROUND

### 1. Field

The application relates to the technical field of wireless communication, and more specifically, to a method of receiving physical downlink control channel (PDCCH) and the corresponding equipment.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broad band (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of band width part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing may be connected to communication networks, and it is accordingly expected that enhanced functions and performances of 5G mobile communication systems and integrated operations of connected devices may be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems may serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “post-LTE systems.”

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### SUMMARY

The base station controls the signal reception and transmission of UE by transmitting physical downlink control channel PDCCH. The base station transmits PDCCH on partial or all resources in a specific downlink time-frequency resource set. To enable the UE to receive PDCCH correctly, the base station needs to configure the downlink time-frequency resource set for the UE. There is a need of an effective method for transmitting or receiving physical downlink control channel (PDCCH).

According to an aspect of the application, there is provided a method performed by user equipment (UE) in a communication system, including: receiving, by the UE, time resource information of a search space configured by a base station; determining, by the UE, the time resource position of the search space according to the time resource information of the search space configured by the base station; determining, by the UE, the times of blind detection for physical downlink control channel (PDCCH)/number of non-overlapping control channel elements (CCE) in the search space.

Optionally, determining, by the UE, the time resource position of the search space according to the time resource information of the search space configured by the base station comprises:
Determining, by the UE, the time span of the search space of the first type according to the time resource information of the search space of the first type; and
Determining, by the UE, the time resource position of the search space of the second type according to the time resource information of the search space of the second type, wherein the time resource position of the search space of the second type only appears in one sub-time window within a predefined time window.

Optionally, determining, by the UE, the time resource position of the search space according to the time resource information of the search space configured by the base station comprises:
Determining, by the UE, the time span of the search space of the first type according to the time resource information of the search space of the first type; and
Determining, by the UE, the time resource position of the search space of the second type according to the time resource information of the search space of the second type, wherein the time resource position of the search space of the second type and the time span of the search space of the first type satisfy a predefined relationship.

Optionally, the relationship comprises at least one of the following:
(1) The distance between the starting point position of the search space of the second type and the starting point of the time span of the immediately preceding search space of the first type is not greater than a first threshold;
(2) The distance between the ending position of the search space of the second type and the starting point of the time span of the immediately following search space of the first type is not less than a second threshold;
(3) The distance between the starting point position of the search space of the second type and the ending position of the time span of the immediately preceding search space of the first type is not less than a third threshold;
(4) The distance between the starting point position of the search space of the second type and the ending position of the time span of the immediately preceding search space of the first type is not greater than a fourth threshold;
(5) The distance between any physical downlink control channel (PDCCH) monitoring occasion (MO) in the search space of the second type and the starting point of the time span of the immediately following search space of the first type is not less than a fifth threshold; or
(6) The distance between any PDCCH MO in the search space of the second type and the ending position of the time span of the immediately preceding search space of the first type is not less than a fifth threshold.

Wherein one or more of the first threshold to the fifth threshold is predefined by standards, or configured by the base station, or reported by the UE.

Optionally, the search space of the first type includes at least one of: user-specific search space (USS), type 3 common search space (CSS), type 1 CSS configured by dedicated RRC signaling, and CSS corresponding to PDCCH with CRC scrambled by a specific type of radio network temporary identifier (RNTI); and the search space of the second type includes at least one of: type 1 CSS, type 0 CSS, type 0A CSS and type 2 CSS which are not configured by dedicated RRC signaling.

Optionally, the method further comprises:
Reducing, by the UE, the times of blind detection for physical downlink control channel (PDCCH)/number of non-overlapping control channel elements (CCE) in the search space according to predefined rules,
Wherein the predefined rules comprise:
   reducing the times of blind detection for PDCCH/number of non-overlapping CCE in the PDCCH search space with low priority.

Optionally, the priority is determined according to at least one of the following:
(1) The priority of the search space of the first type is higher than that of the second type of search space;
(2) The priority of the search space of the second type is higher than that of the first type of search space;
(3) For a plurality of search spaces of the same type, the priority of common search space (CSS) is higher than that of user-specific search space (USS);
(4) For a plurality of CSS in a plurality of search spaces of the same type, the CSS of the first sub-type has the highest priority;
(5) For a plurality of USS in a plurality of search spaces of the same type, the lower the indices of search space set of USS are, the higher the priorities are;
(6) The search space which is earlier in terms of time has higher priority; or
(7) The search space which is earlier in terms of time has lower priority.

Optionally, the CSS of the first sub-type is at least one of the following:
(1) PDCCH CSS with 0 as resource set index and 0 as search space set index;
(2) CSS configured in the main information block (MIB);
(3) CSS configured by non-UE dedicated radio resources control (RRC);
(4) Type 0 PDCCH CSS;
(5) Type 0A PDCCH CSS;
(6) Type 1 PDCCH CSS;
(7) Type 2 PDCCH CSS;
(8) Type 3 CSS; or
(9) Type 3 CSS to which the PDCCH with CRC scrambled by specific type of RNTI belongs.

Optionally, determining, by the UE, the time resource position of the search space according to the time resource information of the search space configured by the base station comprises:
(1) Determining, by the UE, the time span of the search space of the first type according to the time resource information of the search space of the first type; and
(2) For the search space of a specific type, determining an extended time span of the first type including the search space of specific type, by extending the time length of the time span of the search space of the first type.

Optionally, determining, by the UE, the time resource position of the search space according to the time resource information of the search space configured by the base station comprises: determining, by the UE, a time span of the first type for the search space of the first type and a time span of the second type for the search space of the second type, according to the time resource information of the search space.

Optionally, the time resources of the search space are configured to satisfy a predefined relationship.

Optionally, the method further comprises: reducing, by the UE, the times of blind detection for physical downlink control channel (PDCCH)/number of non-overlapping control channel elements (CCE) in the search space by reducing the times of blind detection for PDCCH/number of non-overlapping CCE in the PDCCH search space with low priority.

Optionally, determining, by the UE, the time resource position of the search space according to the time resource information of the search space configured by the base station comprises:
Determining, by the UE, the sliding time window of the physical downlink control channel (PDCCH) according to the time resource information of the search space configured by the base station,
Wherein, in case that the PDCCH search space configured by the base station exceeds the UE's maximum number of the times of blind detection for PDCCH/number of non-overlapping control channel elements (CCE) in the sliding time window, the UE reduces the times of blind detection for PDCCH/the number of non-overlapping control channel elements (CCE) that are actually performed according to predefined rules, so that the PDCCH search space does not exceed UE's maximum number of the times of blind detection for PDCCH/number of non-overlapping control channel elements (CCE).

Optionally, the starting point of the sliding time window is determined according to the reference time point and the size of the sliding step, wherein the reference time point is predefined by standards or configured by the base station, and the size of the sliding step is predefined by standards or reported by the UE or configured by the base station.

Optionally, the predefined rules are at least one of the following:
(1) The UE reduces the times of blind detection (BD) for PDCCH/the number of non-overlapping control channel elements (CCE) in the PDCCH search space in the last M1 slots in the current sliding time window;
(2) The UE reduces the times of blind detection (BD) for PDCCH/the number of non-overlapping control channel elements (CCE) in the PDCCH search space in the last M2 slots in the preceding sliding time window;
(3) The UE reduces the times of blind detection (BD) for PDCCH/the number of non-overlapping control channel elements (CCE) in the PDCCH search space with lower priority in the preceding sliding time window; or
(4) The UE determines the priority of the search space according to the type of PDCCH SS and the index of SS, and reduces the times of blind detection (BD) for PDCCH/the number of non-overlapping control channel elements (CCE) in the search space with lower priority in the preceding sliding time window.

Optionally, common search space (CSS) of a specific type is located in one sub-time window within one time window.

Optionally, the type of the CSS is only one type among the specific types within the one time window, or,
wherein, if the type of the CSS is at least two types among the specific types within the one time window, then:
the at least two types of CSS are located in one same sub-time window; or
the at least two types of CSS are respectively located in two sub-time windows, wherein
the two sub-time windows do not completely overlap.

Optionally, the specific types of CSS are at least one of: type 1 CSS which is not configured based on dedicated radio resource control signaling, as well as type 0 CSS, type 0A CSS and type 2 CSS.

According to another aspect of the application, there is provided a user equipment, including a transceiver and a controller, and the user equipment is configured to perform the above method.

The present disclosure provides a method and apparatus receiving physical downlink control channel (PDCCH).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and additional aspects and advantages of the present application will become more apparent and readily understood, from the following description with reference to the accompanying drawings hereinafter, in which:

FIG. 1 illustrates an example wireless network according to various embodiments of the present disclosure;

FIG. 2a illustrates an example wireless transmission path according to various embodiments of the present disclosure;

FIG. 2b illustrates an example wireless reception path according to various embodiments of the present disclosure.

FIG. 3a illustrates an example user equipment according to various embodiments of the present disclosure;

FIG. 3b illustrates an example base station according to various embodiments of the present disclosure;

FIG. 4 illustrates a method performed by a UE according to various embodiments of the present application;

FIG. 5 illustrates an example of a search space of a UE according to various embodiments of the present disclosure;

FIG. 6 illustrates an example of a search space of a UE according to various embodiments of the present disclosure;

FIG. 7 illustrates an example of a search space of a UE according to various embodiments of the present disclosure;

FIG. 8 illustrates an example of a search space of a UE according to various embodiments of the present disclosure;

FIG. 9 illustrates an example of a search space of a UE according to various embodiments of the present disclosure;

FIG. 10 illustrates an example of a search space of a UE according to various embodiments of the present disclosure;

FIG. 11 illustrates an example of a search space of a UE according to various embodiments of the present disclosure;

FIG. 12 illustrates an example of a search space of a UE according to various embodiments of the present disclosure;

FIG. 13 illustrates an example of a search space of a UE according to various embodiments of the present disclosure;

FIG. 14 illustrates an example of a search space of a UE according to various embodiments of the present disclosure; and

FIG. 15 illustrates an example of a search space of a UE according to various embodiments of the present disclosure.

### DETAILED DESCRIPTION

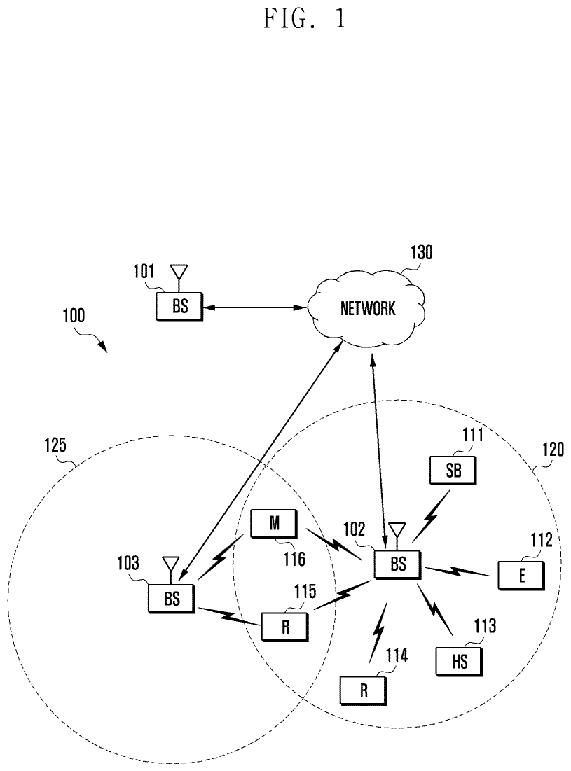

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The technical solution of the embodiments in the present application can be applied to various communication systems, such as global system for mobile communications (GSM) system, code division a plurality of access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5^{th} generation (5G) system or new radio (NR), etc. In addition, the technical solution of the embodiments in the present application can be applied to future-oriented communication technologies.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

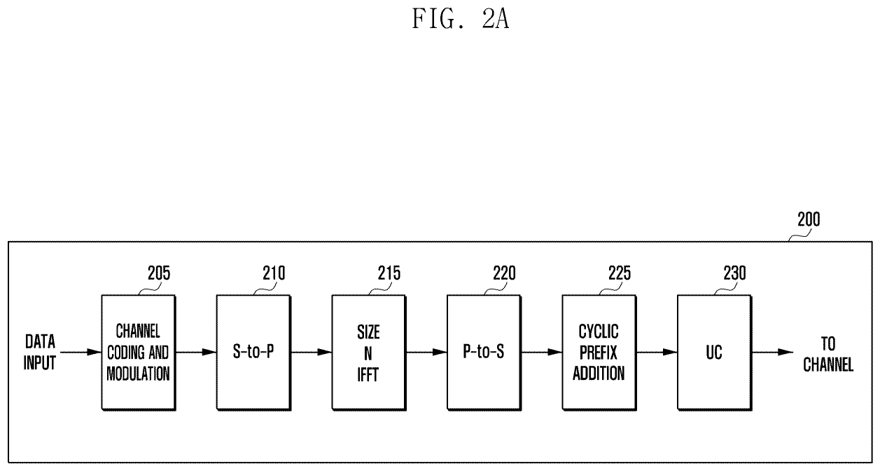

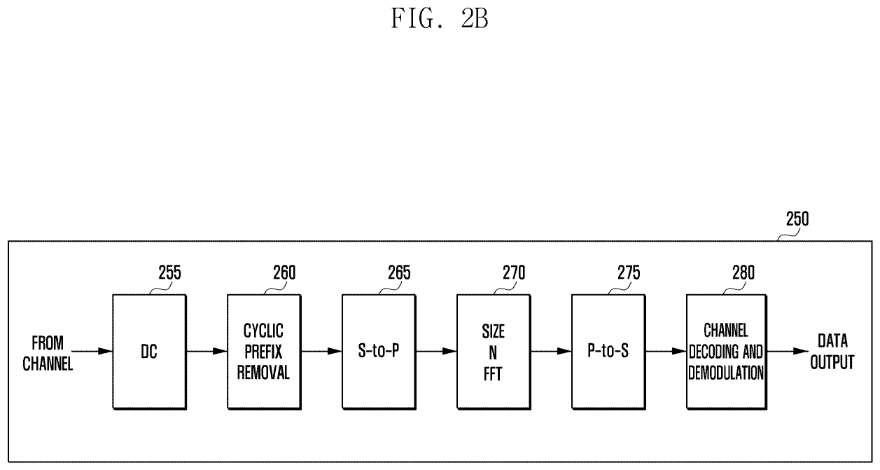

FIGS. 2a and 2b illustrate example wireless transmission and reception paths according to various embodiments of the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N inverse fast Fourier transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The parallel-to-serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

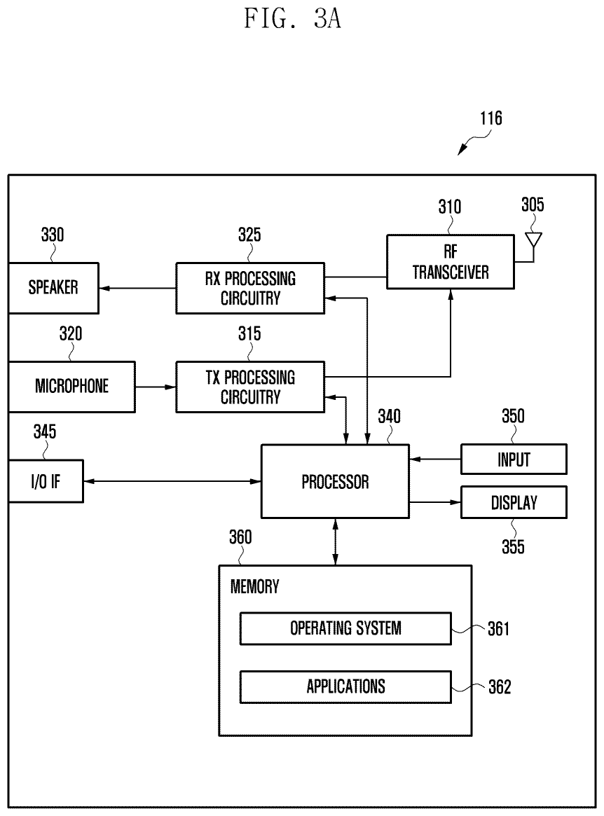

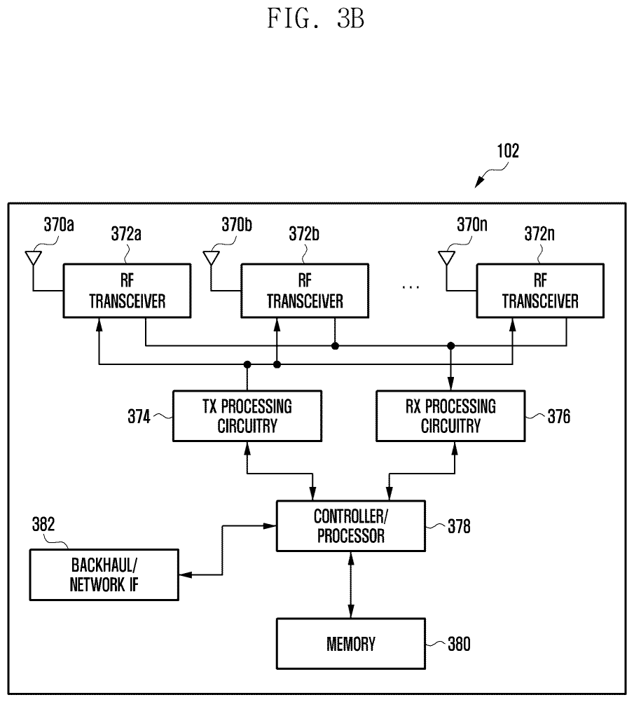

FIG. 3a illustrates an example UE 116 according to various embodiments of the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to various embodiments of the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below with reference to the accompanying drawings.

The text and drawings are provided as examples only to help readers understand the present disclosure. They are not intended and should not be construed as limiting the scope of the present disclosure in any way. Although certain embodiments and examples have been provided, based on the content disclosed herein, it is apparent to those skilled in the art that changes can be made to the illustrated embodiments and examples without departing from the scope of the present disclosure.

The base station controls the signal reception and transmission of UE by transmitting physical downlink control channel PDCCH. The base station transmits PDCCH on partial or all resources in a specific downlink time-frequency resource set. To enable the UE to receive PDCCH correctly, the base station needs to configure the downlink time-frequency resource set for the UE.

For example, in a 5G system, the base station configures a control resource set (coreset) for determining frequency domain resource information for users, for example: physical resource block PRB (such as the PRB where the indication of frequencyDomainResources of CORESET is located), a time resource length (such as the duration indicating the number of OFDM symbols continuously occupied), a mapping method (such as whether the CCE-REG-MappingType indicates a mapping method based on interleaving), and the like. Furthermore, the base station configures a search space (SS) for determining time resource information for the user, for example: period and time offset (such as monitoringSlotperiodicityandoffset), the number of slots continuously occupied in a period (such as duration), starting symbol of each SS area/PDCCH monitoring occasion (PDCCH MO) in one slot (such as monitoringSymbolsWithinSlot), search space type, downlink control information (DCI) format, aggregation levels (AL), numbers of PDCCH candidate (such as nrofCandidates), and the like. Based on these information, the UE can determine the time-frequency resources of each SS area/PDCCH MO, and determine the AL, number of candidates and DCI format of PDCCH candidates within these SS areas/PDCCH MO.

In this application, search space (SS) has the same meaning as search space set (SSS). Although search space or SS is used in the specific description, it can be replaced by search space set or SSS. In addition, in this application, SS area has the same meaning as monitoring occasion, and the SS area and the monitoring occasion can be used interchangeably.

Generally, one PDCCH may contain L1 control channel elements (CCEs), one CCE contains L2 resource element groups (REGs), and one REG contains M PRBs. According to different values of L1, the ALs of PDCCHs are different and the value of AL is the same as the value of L1. For example, when AL=1, L1=1, that is, a PDCCH with AL=1 contains 1 CCE. In the existing 5G system, one CCE contains 6 REGs, that is, L2-6. One REG contains M=1 PRB, where the time unit of the PRB is 1 symbol.

The ability of UE to process PDCCH within one time window length is limited. The UE may report the length of the time window, and the UE's maximum number of the times of blind detection (BD) for PDCCH/number of non-overlapping control channel elements (CCE) within the time window length. Or, the length of the time window is predefined by standards, and the UE reports the UE's maximum number of the times of blind detection (BD) for PDCCH/number of non-overlapping control channel elements (CCE) within the time window length. Or, the length of the time window is predefined by standards, and the UE's maximum number of the times of blind detection (BD) for PDCCH/number of non-overlapping control channel elements (CCE) within the time window length is predefined by standards. Preferably, the length of the time window is related to the subcarrier spacing.

According to an aspect of the application, the time window includes one or more spans. According to one implementation, standards define the maximum number of PDCCH candidates and the maximum number of non-overlapping CCEs that can be detected by the UE terminal in one slot, and the UE terminal may have corresponding processing capabilities to support this number. Tables 1 and 2 illustrates one example. According to another implementation, different UE terminals have different processing capabilities, and the UE terminal reports the maximum number of PDCCH candidates and the maximum number of non-overlapping CCEs that can be supported in one slot to the base station. According to yet another implementation, standards define the maximum number of PDCCH candidates and the maximum number of non-overlapping CCEs that the UE terminal can detect within one time span or monitoring span within one slot, and tables 3 and 4 illustrate one example. One span is the number of consecutive symbols (time dimension) that are configured to monitor PDCCH by the UE within one slot, and one PDCCH monitoring occasion is limited to one span, that is, one PDCCH monitoring occasion cannot exceed one span. The starting point of one span is the starting point of the first PDCCH monitoring occasion (PDCCH MO) within the span, and the one span ends at the ending of the last PDCCH MO within the span. The span is related to the parameter (X, Y), where X is the time distance between the first symbols of two consecutive spans. Y is the time length of one span (that is, the length of a span is at most Y), for example (X, Y)=(2, 2), (4, 3) and (7, 3). The UE may report the supportable (X, Y) combinations to the base station.

TABLE 1
Maximum number of PDCCH candidates monitored within
a single slot of a single serving cell (determined respectively
according to SCS parameter μ ∈ {0, 1, 2, 3}).

| | Maximum number of PDCCH candidates monitored within |
|---|---|
| μ | a single slot of a single serving cell M_{PDCCH}^{max, slot, μ} |
| 0 | 44 |
| 1 | 36 |
| 2 | 22 |
| 3 | 20 |

TABLE 2
The maximum number of non-overlapping CCEs
monitored within a single slot of a single serving cell
(according to SCS parameters μ ∈ {0, 1, 2, 3}).

| | The maximum number of non-overlapping CCEs monitored |
|---|---|
| μ | within a single slot of a single serving cell C_{PDCCH}^{max, slot, μ} |
| 0 | 56 |
| 1 | 56 |
| 2 | 48 |
| 3 | 32 |

TABLE 3
Maximum number of PDCCH candidates monitored in one time
span combination (X, Y) of a single serving cell (determined
respectively according to SCS parameter μ ∈ {0, 1}).

| | Maximum number of PDCCH candidates monitored in one time span | | |
|---|---|---|---|
| | combination (X, Y) of a single serving cell M_{PDCCH}^{max, (X, Y), μ} | | |
| μ | (2, 2) | (4, 3) | (7, 3) |
| 0 | 14 | 28 | 44 |
| 1 | 12 | 24 | 36 |

TABLE 4
The maximum number of non-overlapping CCEs monitored in one
time span combination (X, Y) of a single serving cell (determined
respectively according to SCS parameter μ ∈ {0, 1})

| | Maximum number of non-overlapping CCEs monitored in one | | |
|---|---|---|---|
| | time span combination (X, Y) of a single serving cell | | |
| μ | (2, 2) | (4, 3) | (7, 3) |
| 0 | 18 | 36 | 56 |
| 1 | 18 | 36 | 56 |

The above-described capabilities for PDCCH monitoring and CCE monitoring are based on one slot or one time span with a smaller granularity than a slot. With the increase of subcarrier space (SCS), the slot length is shortened. To maintain the sum of the number of PDCCH monitoring and number of CCE monitoring basically unchanged in an absolute period of time, the PDCCH monitoring and CCE monitoring that UE terminal can support within one slot decreases with the increase of SCS. When the SCS is large, the number of PDCCH monitoring and the number of CCE monitoring that the UE terminal can support within one slot may be so small that it cannot support the basic PDCCH scheduling flexibility requirements or the PDCCH coverage requirements.

For example, when SCS=960 kHz (μ=6), the maximum number of PDCCH monitoring is not enough to support the number of PDCCH monitoring required for the PDCCH which schedules system information. With capabilities for PDCCH monitoring and CCEs monitoring which are based on greater time granularity, for example based on slot group (one slot group consists of a plurality of slots) or time window (one time window consists of a plurality of slots), or with capabilities for PDCCH monitoring and CCEs monitoring which are based on the span larger than one slot, it can support more flexible PDCCH configuration and obtain a better compromise between the time interval of PDCCH monitoring occasion and the number of PDCCH monitoring and the number of CCEs monitoring within each PDCCH monitoring occasion.

As for machine-type control (MTC) user equipment (UE) and Internet-Of-Things (IoT) UE such as Narrowband Internet of Things (NB-IoT), to prolong the service life of batteries and reduce costs, it can also adopt capabilities for PDCCH monitoring and CCE monitoring defined based on larger time granularity, thereby reducing the PDCCH monitoring complexity and processing capability requirements of the UE terminal. In addition to changing the capabilities of UE terminal to detect PDCCH/CCE, it can also reduce the pressure of UE terminal to detect PDCCH and reduce the power consumption of UE terminal by reducing the actual maximum number of PDCCH/CCE to be detected.

To support a wider and more flexible span, the unit of X can be symbol, slot, sub-slot or slot group, and the unit of Y can be symbol, slot, sub-slot or slot group. For example, if the unit of X is slot and the unit of Y is symbol, (X, Y)=(8, 3) means that the length of one span does not exceed 3 symbols, and the interval between the starting points of any two spans is not less than 8 slots.

Because the number of PDCCH that UE can detect within unit time is limited. If the interval between the starting points of two spans is too small, the UE may monitor the PDCCH in the former span, which may affect the monitoring of the PDCCH in the latter span. For example, the UE may be unable to complete the detection of all PDCCHs in the former span before the start of the latter span, resulting in that the UE cannot be able to start the PDCCH detection in the latter span in time. Therefore, the value of X may not be too small. In addition, it is also necessary to consider that the interval from the ending position of the last PDCCH MO in the first span of the two temporally adjacent spans to the starting position of the first PDCCH MO in the second span cannot be too small.

Otherwise, the UE may not be able to complete the detection of all PDCCHs in the former span before the start of the latter span, resulting in that the UE cannot be able to start the PDCCH detection in the latter span in time. Therefore, the value of Y cannot be too large, or the value of (X-Y) cannot be too small. If the units of x and y are different, the interval from the ending position of the last PDCCH MO in the first span to the starting position of the first PDCCH MO in the second span may be determined after unifying the units. For example, if the unit of X is slot and the unit of Y is symbol, the interval may be greater than (X-14*Y). For convenience of description, all the following are expressed as (X-Y), without considering the influence of different units.

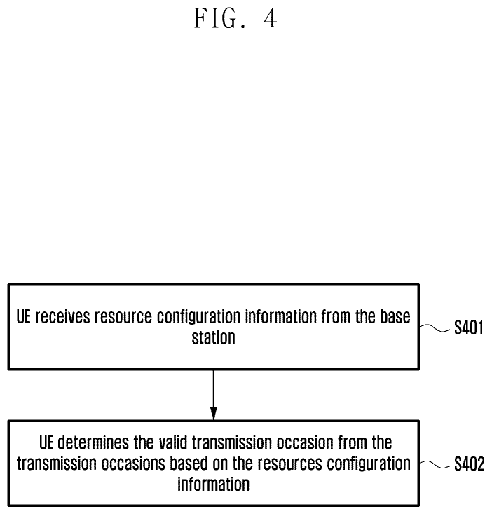

FIG. 4 illustrates a method performed by a UE according to various embodiments of the present application.

In 401, the UE receives the search space configured by the base station.

In 402, the UE determines the span of the search space according to the time resource information of the search space configured by the base station.

The time resource information of the search space (SS) includes the period and time offset of each SS set, slot and symbol information available for SS within one period, etc.

According to one implementation of the present disclosure, in the case where one type of span is configured by the base station, the UE determines the span of the search space of a specific type according to the time resources of the search space configured by the base station. The search space of specific type (also called the search space of the first type) is at least one of the following:
(1) User-specific search space (USS);
(2) Common search space (CSS) of a specific type;
(3) Preferably, CSS of the specific type is a Type-3 CSS;
(4) Preferably, CSS of the specific type is a Type-1 CSS configured by dedicated RRC signaling; or
(5) Preferably, CSS of the specific type includes a CSS corresponding to PDCCH with CRC scrambled by a specific type of radio network temporary identifier (RNTI). For example, the RNTI of the specific types are C-RNTI, MCS-C-RNTI and CS-RNTI.

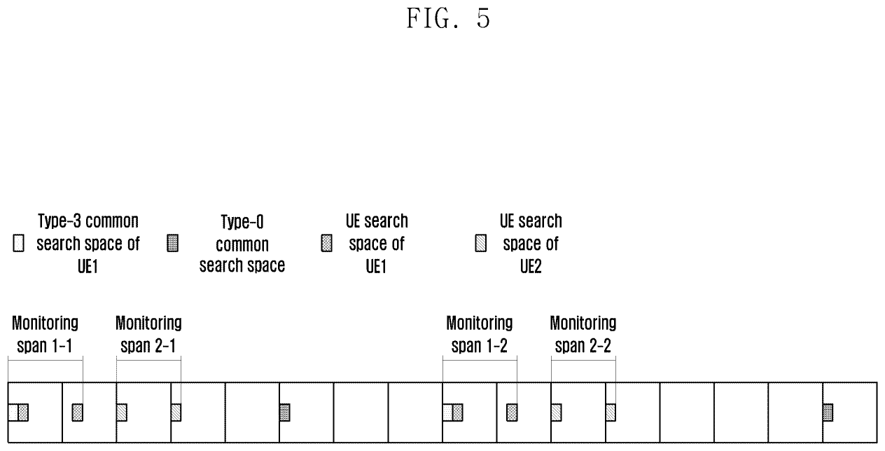

FIG. 5 illustrates an example of a search space of a UE according to various embodiments of the present disclosure. As illustrated in FIG. 5 as an example, for UE1, there are two spans: span1-1 and span1-2, which consist of the Type-3 common search space of UE1 and the user-specific search space of UE1. For UE2, there are two spans, span2-1 and span2-2, which consist of the user-specific search space of UE2. Although UE1 and UE2 are both required to detect the Type-0 common search space, the span is not determined according to this search space. The Type-0 common search space are usually the search spaces that all UEs within one cell are required to monitor, but the UE search spaces of each UE are different, and it is likely that the UE search spaces of each UE are spread in terms of time.

For example, USSs of different UE are located in different slots, thus it is difficult for the base station to configure both the Type-0 CSS and the UE search spaces of each UE within a range of Y consecutive symbols/slots within one span. For example, as for (X, Y)=(8 slots, 2 slots), as the configuration of PDCCH search space in FIG. 5, it cannot be realized that for UE1 or UE2, USS and Type-0 CSS of UE1 are limited to 2 consecutive slots respectively, and USS and Type-0 CSS of UE2 are limited to 2 consecutive slots. Therefore, this type of incongruous common search spaces (also known as the search space of the second type) may be handled separately.

According to one implementation, while configuring SS, the base station needs to satisfy that: the span which consist of the search spaces of the first type satisfies the constraint of (X, Y), and the time resource position of the search spaces of the second type is not limited by (X, Y). The search spaces of the second type are at least one of the following:
(1) sType-1 CSS, which is not configured based on dedicated RRC signaling, for example, Type-1 CSS configured through PDCCH-Configcommon;
(2) Type-0 CSS;
(3) Type-0A CSS; or
(4) Type-2 CSS.

To control the complexity of detecting PDCCH of the search space of the second type by the UE, time resources of the search space of the second type may be limited.

According to one implementation, the time resource position of the search space of the second type configured by the base station satisfies that: it only appears in one sub-time window within one predefined time window. Wherein, the length of the sub-time window is L, that is, the search spaces of the second type only appears in L consecutive symbols within one time window. The time window may be independent of the span which consist of the search space of the first type. For example, the time window is Ls consecutive slots with slot n*Ls as the starting point and slot (n+1)*Ls−1 as the ending point, where n=0,1, . . . , and Ls is predefined by standards, reported by UE, configured by base station, or calculated according to predefined methods. For example, the value of Ls is determined according to the relationship between the subcarrier spacing (SCS1) of the BWP where PDCCH is located and the reference subcarrier spacing (SCS2). Taking SCS2=120 KHz as an example, the value of Ls is determined according to one slot length corresponding to 120 KHz, thus Ls=8.

Preferably, there are at most Ns PDCCH Mos of the search space of the second type between two spans of the search space of the first type, wherein Ns≥1.

Accordingly, the UE may report whether the UE supports the detection of the search space of the first type in the span satisfying the constraint of (X, Y), and the detection of the search space of the second type in the time window/sub-time window satisfying the corresponding constraint relationship.

According to another implementation, the time resource position of the search space of the second type configured by the base station satisfies: the span which consist of the search space of the first type satisfies the constraint of (X, Y), and the search space of the second type satisfies a specific constraint relationship with the span. The constraint relationship is: the distance between the starting point position of the search space of the second type and the starting point of the immediately preceding span does not exceed a first threshold Z1; or the distance between the ending position of the search space of the second type and the starting point of the immediately following span is not less than a second threshold Z2; or the distance between the starting point position of the search space of the second type and the ending position of the immediately preceding span is not less than a third threshold Z3; or, the distance between the starting point position of the search space of the second type and the ending position of the immediately preceding span does not exceed a fourth threshold Z4; or the distance between any PDCCH MO in the search space of the second type and the starting point of the immediately following span is not less than a fifth threshold Z5; or, the distance between any PDCCH MO in the search space of the second type and the ending position of the immediately preceding span is not less than Z5, wherein one or more of the first threshold Z1 to the fifth threshold Z5 is predefined by standards, configured by the base station, or reported by the UE.

Preferably, the distances are related to the subcarrier spacing. Preferably, there are at most Ns PDCCH MOs of the search space of the second type between two spans. In this way, the flexibility of configuring CSS by the base station may be supported, and the increased PDCCH detection burden of UE caused by CSS may be reduced. Accordingly, the UE may report whether the UE supports the detection of the search space of the first type in the span satisfying the constraint of (X, Y) and the detection of the search space of the second type satisfying the corresponding constraint relationship.

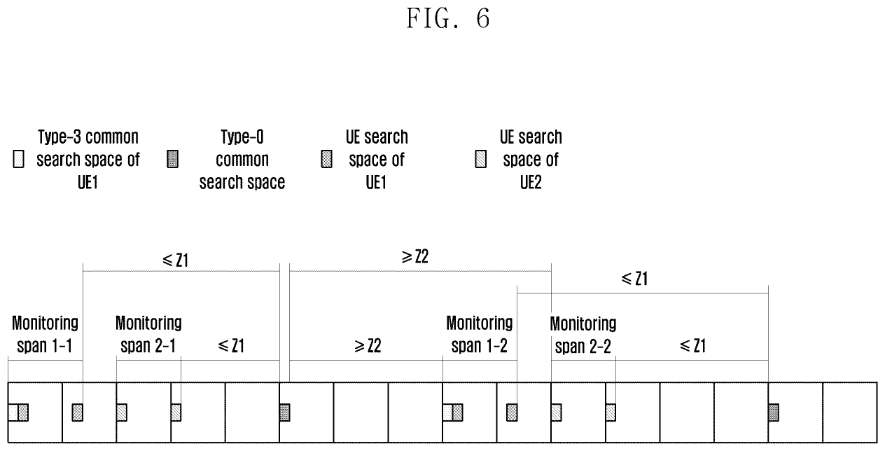

FIG. 6 illustrates an example of a search space of a UE according to various embodiments of the present disclosure. As shown in FIG. 6, for UE1, there are two spans, span1-1 and span1-2, which consist of the Type-3 common search space of UE1 and the user-specific search space of UE1. For UE2, there are two spans, span2-1 and span2-2, which consist of the user-specific search space of UE2. For UE1, Type-0 CSS is located out of monitoring span 1-1 and monitoring span 1-2, but the time interval between Type-0 CSS and the ending position of monitoring span 1-1 does not exceed Z1. For UE2, Type-0 CSS is located out of monitoring span 2-1 and monitoring span 2-2, but the time interval between Type-0 CSS and the ending position of monitoring span 1-1 does not exceed Z1.

According to an aspect of this application, as an alternative to the above described constraint relationship, or based on the above described constraint relationship, in order to contain the PDCCH monitoring complexity within the capability reported by the UE, the base station may limit the times of blind detection (BD) for PDCCH/number of non-overlapping control channel elements (CCE) within the search space of the second type according to predefined rules; or, the UE reduces the times of blind detection (BD) for PDCCH/number of non-overlapping control channel elements (CCE) within the search space of the second type according to predefined rules, or the UE reduces the times of blind detection (BD) for PDCCH/number of non-overlapping control channel elements (CCE) in the previous or next span spatially adjacent to the search space of the second type according to predefined rules.

By the UE, reducing the times of blind detection (BD) for PDCCH/number of non-overlapping control channel elements (CCE) within in the search space of the second type according to predefined rules, or reducing the times of blind detection (BD) for PDCCH/number of non-overlapping control channel elements (CCE) in the previous or next span spatially adjacent to the search space of the second type according to predefined rules, comprises: reducing the times of blind detection for PDCCH/number of non-overlapping CCE in the PDCCH SS with low priority. The priority is determined according to at least one of the following:
(1) The priority of the search space of the first type is higher than that of the second type of search space. That is, the priority of SS for determining span is higher than that of SS not for determining span;
(2) The priority of the search space of the second type is higher than that of the first type of search space; or
That is, the priority of SS for determining span is lower than that of SS not for determining span.

For a plurality of search spaces of the same type, determine the priority of a plurality of search spaces according to at least one of the following methods:
The priority of CSS is higher than that of the USS.

Preferably, among a plurality of CSS in a plurality of search spaces of the same type, the CSS of the first sub-type has the highest priority. The CSS of the first subtype is at least one of the following:
(1) PDCCH CSS with a CORESET index=0 and a search space set index=0;
(2) CSS configured in MIB;
(3) Type-0 PDCCH CSS;
(4) Type 0A PDCCH CSS;
(5) Type-1 PDCCH CSS;
(6) Type-2 PDCCH CSS;
(7) Type-3 CSS; or
(8) Type-3 CSS including PDCCH with CRC scrambled by RNTI of specific type.

Preferably, the RNTI of specific type is at least one of INT-RNTI, SFI-RNTI, and CI-RNTI.

In a plurality of USSs in a plurality of search spaces of the same type, the lower the indices of search space set of USS are, the higher the priorities are.

The search space which is earlier in terms of time has higher priority. For example, if the search space of the first type is earlier in terms of time than the search space of the second type, the priority of the search space of the first type is higher. If the search space of the second type is earlier in terms of time than the search space of the first type, the priority of the search space of the second type is higher.

The search space which is earlier in terms of time has lower priority. For example, if the search space of the first type is earlier in terms of time than the search space of the second type, the priority of the search space of the second type is higher. If the search space of the second type is earlier in terms of time than the search space of the first type, the priority of the search space of the first type is higher.

According to one implementation, when the first PDCCH MO of the SS with high priority starts, if there are unfinished detections of the PDCCH of the SS with low priorities, the detections of the PDCCH with low priority are aborted. According to one implementation, when the first PDCCH MO of the SS with low priority starts, if there are unfinished detections of the PDCCH of the SS with high priorities, the detections of the PDCCH with high priority continue. For PDCCHs of SS with low priority, the detections of PDCCHs in SS with low priority are reduced, or the detections of PDCCHs in SS with low priority are aborted.

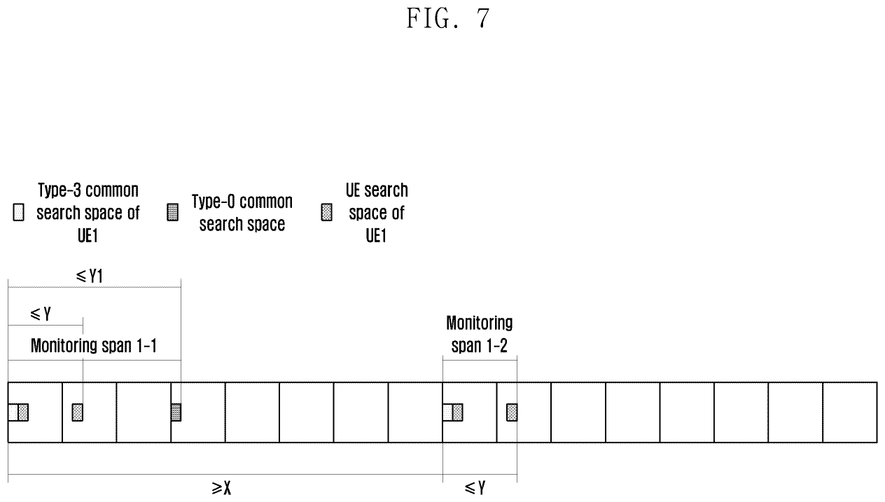

According to another implementation of the present disclosure, when one type of span is configured by the base station, the UE determines the span of the SS of the first type according to the time resources of the SS configured by the base station for the UE. Except for SS of specific type, the time resource configuration of other SS needs to enable the determined span satisfying the constraint of (X, Y). The span of Y may be extended for a specific type of SS, that is, the length of the span where the SS of the specific type is located is Y1 symbols, and Y1 may be larger than Y, in order to determine the span of the search space of specific type. Preferably, the SS of specific type is the SS of the second type (which has been described above and will not be repeated). FIG. 7 illustrates an example of the search space of the UE according to various embodiments of the present disclosure, wherein X=8 slots, Y=2 slots, Y1=3 slots, and the monitoring spans 1-1 and 1-2 are used to represent PDCCH MOs that are different in terms of time.

According to one implementation, for the span where the SS of specific type is located, the times of blind detection (BD) for PDCCH/number of non-overlapping control channel elements (CCE) configure by the base station may exceed the number reported by the UE. In this case, the UE reduces the times of blind detection (BD) for PDCCH/number of non-overlapping control channel elements (CCE) according to the predefined rules, so as not to exceed the reporting capability of the UE. The predefined rules may refer to the method described in the present disclosure and will not be repeated.

According to another implementation of the present disclosure, in the case that at least two types of spans are configured by the base station, the UE determines the span of the first type for the search space of the first type and the span of the second type for the search space of the second type according to the time resource information of the search space. Spans of different types may not overlap, or spans of different types may overlap. The values of (X, Y) of spans of different types may be the same or different. The units of (X, Y) of spans of different types may be the same or different. For spans of different types, UE's maximum number of the times of blind detection (BD) for PDCCH/number of non-overlapping control channel elements (CCE) supported by UE are defined respectively. Or, for spans of different types, UE's maximum number of the times of blind detection (BD) for PDCCH/number of non-overlapping control channel elements (CCE) are defined to be the same. The UE reports the span types and the (X, Y) corresponding to each span type, and the maximum number of the times of blind detection (BD) for PDCCH/number of non-overlapping control channel elements (CCE) when reporting the capability.

Generally, for spans of the same type, it is necessary to ensure that the interval between the starting points of two temporally adjacent spans is not less than the predefined threshold Th1(X), and also necessary to ensure that the interval between the ending position of the last PDCCH MO in the first span and the starting point position of the first PDCCH MO in the second span of two temporally adjacent spans is not less than the predefined threshold Th2(X-Y). With this restriction, the impact of PDCCH detection in the former span on PDCCH detection in the latter span may be reduced. If there are different types of spans, although within the spans of the same type it satisfies that the interval between the starting points of two adjacent spans is not less than the predefined threshold Th1, and the interval between the ending position of the last PDCCH MO in the first span and the starting point position of the first PDCCH MO in the second span is not less than the predefined threshold Th2, different types of spans may appear alternately in the time dimension, resulting in a smaller interval between spans of two different types.

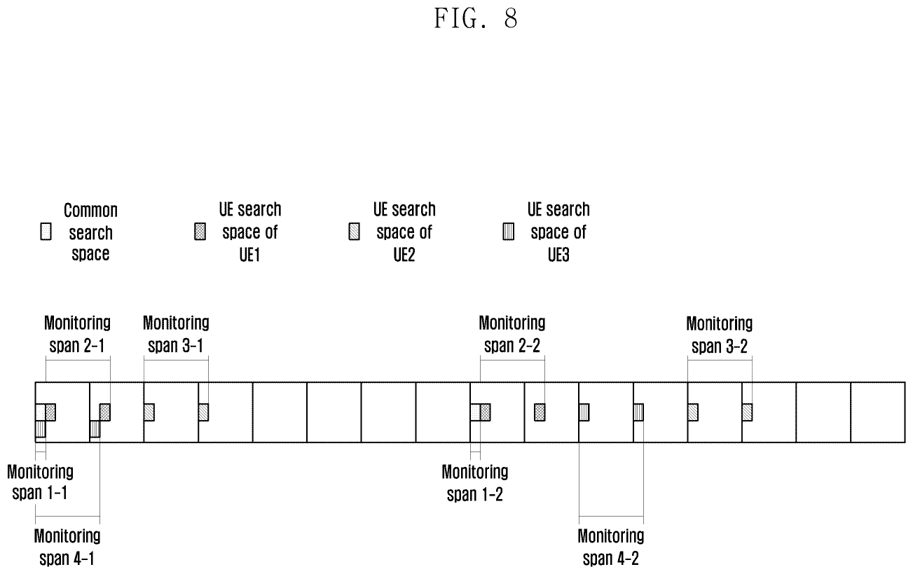

FIG. 8 illustrates an example of a search space of a UE according to various embodiments of the present disclosure. For example, as illustrated in FIG. 8, all of UE 1, UE 2 and UE 3 need to monitor PDCCH in search space of a first type, such as common search space of specific type of, and also need to monitor PDCCH in search space of second type, such as to monitor PDCCH in each UE search space. The monitoring span determined by the common search space is 1-k, where k=1, 2, . . . , which represents different PDCCH MOs in terms of time. The monitoring span which includes UE search space of UE1 is 2-k, where k=1, 2, . . . ; the monitoring span which consist of UE search space of UE2 is 3-k, where k=1, 2, . . . ; and the monitoring span which consist of UE search space of UE3 is 4-k, where k=1, 2, . . . For UE2, if the monitoring span of the common search space is not considered, the interval between any two spans (monitoring spans 3-1 and 3-2, which belong to the span of the same type) which consist of the UE search space of UE2 satisfies ≥10 slots (Th1=10 slots), and the interval between the last PDCCH MO of the former span and the starting point of the latter span satisfies ≥8 slots (Th2-8 slots).

Since the monitoring span 1-2 of the common search space is located between the monitoring spans 3-1 and 3-2, and the monitoring span 1-1 of the common search space is located before the monitoring span 3-1, so the time interval between each span of the PDCCH that the UE needs to monitor is 2 slots (the interval between span1-1 and span 3-1), 6 slots (the interval between span3-1 and span1-2), and 4 slots (the interval between span1-2 and span3-2).

To avoid the case that the PDCCH that needs to be detected by the UE exceeds the capabilities for the maximum number of the times of blind detection (BD) for PDCCH/number of non-overlapping control channel elements (CCE) that can be supported by UE, due to the small interval between adjacent spans, the span of the first type and the span of the second type may be configured and/or determined by at least one of the following examples.

In one example of (1), when configuring the time resources of search space of the PDCCHs within the span of the same type, the base station ensures that the time resources of search space of any PDCCH within the type of span may not cause the intervals between a plurality of spans of this type to be less than the predefined threshold Th1. The threshold is predefined by standards or determined by UE capability reported by the UE. When configuring the time resources of search space of the PDCCH within the span of the same type, the base station ensures that the time resources of search space of any PDCCH within the type of span may not cause the intervals from the last PDCCH MO of the former Span to the first PDCCH MO of the latter span to be less than the predefined threshold Th2. The threshold is predefined by standard or determined by UE capability reported by the UE.

In another example of (2), when configuring the time resources of search space of PDCCHs, the base station ensures that the time resources of search space of any PDCCH may not cause the intervals between two temporally adjacent spans of different types to be less than the predefined threshold Th3. The threshold is predefined by standards or determined by UE capability reported by the UE.

In yet another example of (3), when configuring the time resources of search space of PDCCHs, the base station ensures that the time resources of search space of any PDCCH may not cause the intervals between the last PDCCH MO of the former span and the first PDCCH MO of the latter span to be less than the predefined threshold Th4, wherein the former span and the latter span are of different types. The threshold is predefined by standards or determined by UE capability reported by the UE.

In yet another example of (4), if the time resources of search space of PDCCHs configured by the base station causes intervals between a plurality of spans of different types to be less than the predefined threshold Th, UE's maximum number of the times of blind detection (BD) for PDCCH/number of non-overlapping control channel elements (CCE) for at least one span may be reduced according to predefined rules. The threshold is predefined by standards or determined by UE capability reported by the UE.

In yet another example of (5), if the time resources of search space of PDCCHs configured by the base station causes the intervals between the last PDCCH MO of the former span and the first PDCCH MO of the latter span to be less than the predefined threshold Th, wherein the former span and the latter span are of different types, UE's maximum number of the times of blind detection (BD) for PDCCH/number of non-overlapping control channel elements (CCE) for at least one span may be reduced according to predefined rules. The threshold is predefined by standards or determined by UE capability reported by the UE.

In (4) or (5), according to predefined rules, reducing UE's maximum number of the times of blind detection (BD) for PDCCH/number of non-overlapping control channel elements (CCE) for at least one span comprises: reducing the number of PDCCH blind detections (BD) times/the number of non-overlapping control channel element (CCE) of the PDCCH SS with lower priority. According to one implementation, when the first PDCCH MO of the SS with high priority starts, if there are unfinished detections of the PDCCH of the SS with low priorities, the detections of the PDCCH with low priority are aborted. According to one implementation, when the first PDCCH MO of the SS with low priority starts, if there are unfinished detections of the PDCCH of the SS with high priorities, the detections of the PDCCH with high priority continue. For PDCCHs of span with low priority, the detections of PDCCHs in span with low priority are reduced, or the detections of PDCCHs in span with low priority are aborted.

The priority of span is determined according to at least one of the following:
(1) a span including the search space of the second type has higher priority than a span including the search space of the first type;
(2) a span including the search space of the second type has lower priority than a span including the search space of the first type; or
(3) a span including the CSS of the first type has higher priority than a span including the USS and the CSS of the second type.

The CSS of the first type is at least one of the following:
(1) PDCCH CSS with CORSET index=0 and Search space set index=0;
(2) CSS configured in MIB;
(3) Type-0 PDCCH CSS;
(4) Type 0A PDCCH CSS;
(5) Type-1 PDCCH CSS;
(6) Type-2 PDCCH CSS;
(7) Type-3 CSS; or
(8) Type-3 CSS including PDCCH with CRC scrambled by RNTI of specific type.

Preferably, the RNTI of specific type is at least one of INT-RNTI, SFI-RNTI, and CI-RNTI.
A span including USS has a higher priority than a span including CSS of the third type.

The CSS of second type of is at least one of the following:
(1) PDCCH CSS with CORSET index=0 and Search space set index=0;
(2) CSS configured in MIB;
(3) Type-0 PDCCH CSS;
(4) Type 0A PDCCH CSS; or
(5) Type-3 CSS including PDCCH with CRC scrambled by RNTI of specific type.

Preferably the RNTI of the specific type is TPC-PUSCH-RNTI, TPC-PUCCH-RNTI, TPC-SRS-RNTI, or CI-RNTI, and at least one of C-RNTI, MCS-C-RNTI, CS-RNTI or PS-RNTI only for the primary cell.

The priority of the span which is earlier in terms of time is higher than that of the span which is later in terms of time.

The priority of the span which is later in terms of time is higher than that of the span which is earlier in terms of time.

In (4) or (5), according to predefined rules, reducing UE's maximum number of the times of blind detection (BD) for PDCCH/number of non-overlapping control channel elements (CCE) for at least one span comprises: determine UE's reduced number of the times of blind detection for PDCCH/number of non-overlapping control channel elements (CCE) of each Span, according to the relationship between the interval between two spans (the interval between the starting points of two spans, and/or the interval between the last PDCCH MO of the former span and the first PDCCH MO of the latter span) and predefined thresholds.

For example, in FIG. 8, for UE2, the minimum interval of Span1-k is Th1=8 slots, and the minimum interval of Span 3-k is Th2=10 slots, where k=1, 2. The interval between span 1-1 and span 3-1 is 6 slots, thus, UE's maximum number of the times of blind detection for PDCCH/number of non-overlapping control channel elements (CCE) in Span 1-1 are α*M1 and α*C1, respectively, where α is determined by the relationship between the interval between two spans and the threshold Th1 corresponding to span1-1, for example, α=floor (the interval between Span 1-1 and span3-1/Th1). The UE's maximum number of the times of blind detection for PDCCH/number of non-overlapping control channel elements (CCE) in Span3-1 are α*M2 and α*C2, respectively, where a is determined by the relationship between the interval between two spans and the threshold Th2 corresponding to Span3-1, for example, α=floor (the interval between span3-1 and span1-2/Th2).

If spans of different types at least partially overlap, determine UE's maximum number of the times of blind detection for PDCCH/number of non-overlapping control channel elements (CCE) in the time resources of these spans according to at least one of the following example.

If in the capabilities reported by the UE, UE's maximum number of the times of blind detection for PDCCH/number of non-overlapping control channel elements (CCE) are different for spans of different types, for example, if UE's maximum number of the times of blind detection for PDCCH/number of non-overlapping control channel elements (CCE) for the span of the first type is M1/C1, and UE's maximum number of the times of blind detection for PDCCH/number of non-overlapping control channel elements (CCE) for the span of the second type is M2/C2, then:

In one example of (A), determine UE's maximum number of the times of blind detection for PDCCH/number of non-overlapping control channel elements (CCE) within the total time length of partially overlapping spans, according to the maximum among UE's maximum numbers of the times of blind detection for PDCCH/number of non-overlapping control channel elements (CCE) in a plurality of overlapping spans, or

In another example of (B), determine UE's maximum number of the times of blind detection for PDCCH/number of non-overlapping control channel elements (CCE) within the total time length of partially overlapping spans, according to the sum of each UE's maximum numbers of the times of blind detection for PDCCH/number of non-overlapping control channel elements (CCE) in a plurality of overlapping spans.

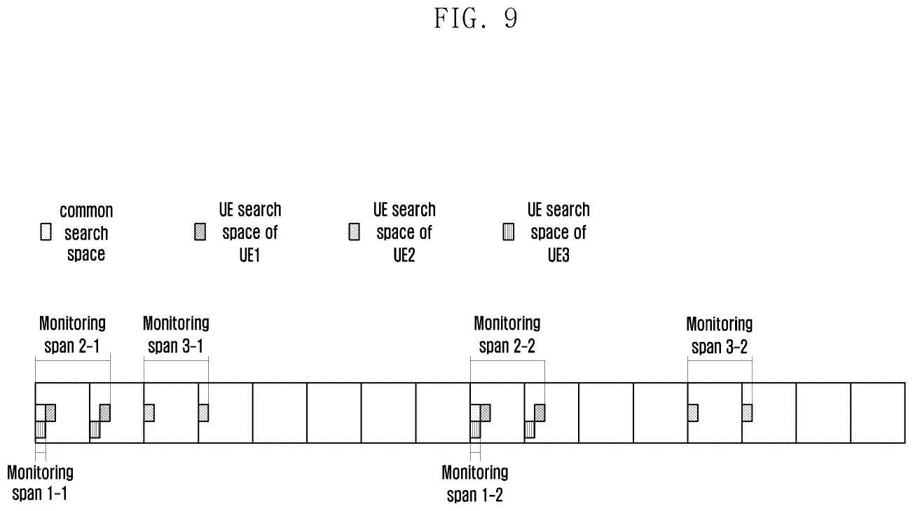

FIG. 9 illustrates an example of a search space of a UE according to various embodiments of the present disclosure. For example, as illustrated in FIG. 9, both UE1 and UE2 need to monitor PDCCH in the common search space, and also need to monitor PDCCH in each UE's search space. The monitoring span determined by the common search space is 1-k, where k=1, 2, . . . , which represents different PDCCH MO in terms of time. The monitoring span which consists of UE search space of UE1 is 2-k, where k=1, 2 . . . , including 2 UE search spaces. The monitoring span which includes UE search space of UE2 is 3-k, where k=1, 2, . . . For UE1, the monitoring span which consists of the common search space partially overlaps with the monitoring span which consists of UE search space, taking method (1) as an example, in the union of the set which consists of the monitoring span 1-1 and the detection span 2-1, UE's maximum number of the times of blind detection (BD) for PDCCH is max(M1,M2), and the maximum number of non-overlapping control channel element (CCE) is max(C1,C2).

To mitigate the situation that the burden of detecting PDCCH by the UE in a relatively short period of time increases and even exceeds the processing capacity of UE, due to the overlapping of spans of different types, it may be implemented by at least one of the following:
(1) While configuring the search space of PDCCH, the base station ensures that the sum of the times of blind detection (BD) for PDCCH/number of non-overlapping control channel elements (CCE) configured for a plurality of overlapping spans of different types does not exceed UE's maximum number of the times of blind detection (BD) for PDCCH/number of non-overlapping control channel elements (CCE) determined according to the method (A) or (B); or
(2) If the search space of PDCCH configured by the base station causes the sum of the times of blind detection (BD) for PDCCH/number of non-overlapping control channel elements (CCE) configured for a plurality of overlapping spans of different types to exceed UE's maximum number of the times of blind detection (BD) for PDCCH/number of non-overlapping control channel elements (CCE) determined according to the method (A) or (B), then UE's maximum number of the times of blind detection (BD) for PDCCH/number of non-overlapping control channel elements (CCE) for at least one span may be reduced according to predefined rules. The method for reducing UE's maximum number of the times of blind detection (BD) for PDCCH/number of non-overlapping control channel elements (CCE) for at least one span may refer to the method described above, and will not be repeated.

As described above, the capability of UE to process PDCCH within one time window length is limited. According to another aspect of the present application, the starting point of the time window may slide, and the size of the sliding step is predefined by standards, or reported by the UE, or configured by the base station. Such a time window is called a sliding time window. The starting point of the sliding time window is determined according to the reference time point and the size of the sliding step. The reference time point is predefined by standards or configured by a base station.

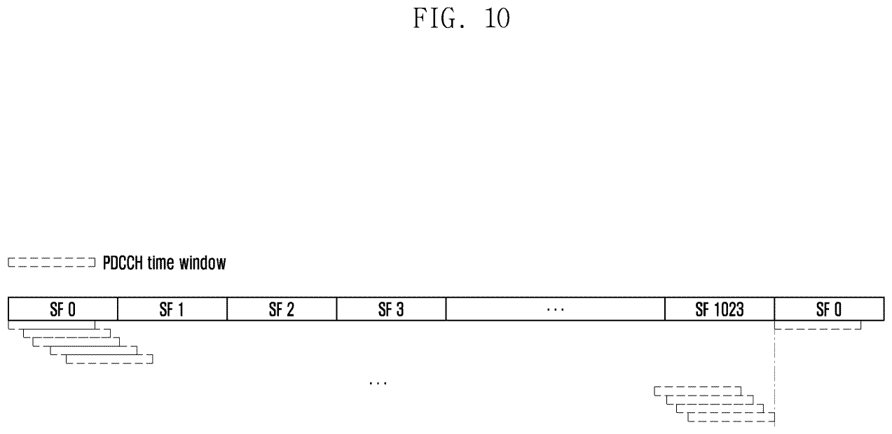

For example, taking the system frame (SF) 0 as the reference time point, the time window length is 8 slots, and the size of the sliding step is 1 slot. It is assumed that one SF contains 640 slots, then the first time window is the 1st to 8th slot of SF 0, the second time window is the 2nd to 9th slot of SF 0, . . . the Nth time window is the 633rd to 640th slot of SF 1023, and the N+1th time window is the 1st to 8th slot of SF 0. It is not difficult to see that the time window does not slide at all time, but rather restarts to determine the starting point at every SF 0, as illustrated in FIG. 10. FIG. 10 illustrates an example of a search space of a UE.

In order to control the cumulative effect of time window sliding, the time position or period N for restarting to determine the time window starting point may be predefined by standards or configured by base station. For example, the base station configures the period N for restarting to determine the starting point of the sliding time window to be 1 SF or 10 seconds, then the starting point of the first time window within the SF is determined to be the first slot within the SF. In the above example, SF0 is taken as the starting point for restarting to determine, which is equivalent to N=1024 SFs.

Within each sliding time window, the times of blind detection (BD) for PDCCH/the number of non-overlapping control channel elements (CCE) that are actually performed by the UE is less than or equal to the UE's maximum number of the times of blind detection (BD) for PDCCH/number of non-overlapping control channel elements (CCE).

According to one implementation, when configuring PDCCH SS, the base station needs to ensure that the times of blind detection (BD) for PDCCH/the number of non-overlapping control channel elements (CCE) to be detected within each sliding time window is less than or equal to the UE's maximum number of the times of blind detection (BD) for PDCCH/number of non-overlapping control channel elements (CCE).

According to another implementation, in order to reduce the restrictions on PDCCH SS configuration, the PDCCH SS configured by the base station may be allowed to exceed UE's maximum number of the times of blind detection (BD) for PDCCH/number of non-overlapping control channel elements (CCE) within certain sliding time windows, but the UE needs to control the times of blind detection (BD) for PDCCH/the number of non-overlapping control channel elements (CCE) that are actually performed according to predefined rules, so that it does not exceed UE's maximum number of the times of blind detection (BD) for PDCCH/number of non-overlapping control channel elements (CCE).

The predefined rules are at least one of the following examples:

In one example of (1), if the PDCCH SS configured by the base station causes the times of blind detection (BD) for PDCCH/the number of non-overlapping control channel. elements (CCE) to be processed by the UE within one sliding time window exceed the UE's maximum number of the times of blind detection (BD) for PDCCH/number of non-overlapping control channel elements (CCE), the UE reduces the times of blind detection (BD) for PDCCH/the number of non-overlapping control channel elements (CCE) in the PDCCH SS in the last M1 slots in the current sliding time window until the times of blind detection (BD) for PDCCH/the number of non-overlapping control channel elements (CCE) to be processed does not exceed UE's maximum number of the times of blind detection for PDCCH/number of non-overlapping control channel elements (CCE), where M1≥1.

Preferably, M1 is configured to be less than or equal to the size of the sliding step of the sliding time window. Preferably, when M1>1, in the M1 slots, according to the time sequence, or according to the types of SS, or according to the index of SS, the times of blind detection (BD) for PDCCH/the number of non-overlapping control channel elements (CCE) to be processed within the M1 slots are reduced, so that the times of blind detection (BD) for PDCCH/the number of non-overlapping control channel elements (CCE) to be processed within the slots does not exceed the maximum value. The time sequence is to: preferentially reduce the times of blind detection (BD) for PDCCH/the number of non-overlapping control channel elements (CCE) to be processed within the slots which is later in terms of time, or the slots with which is earlier in terms of time. The types or index of SS is: preferentially reducing the times of blind detection (BD) for PDCCH/the number of non-overlapping control channel elements (CCE) of USS to be detected, and preferentially reducing the times of blind detection (BD) for PDCCH/the number of non-overlapping control channel elements (CCE) of USS with larger SS index among USS.

In this way, the PDCCH SS within the same slot may only reduce the times of blind detection (BD) for PDCCH/the number of non-overlapping control channel elements (CCE) once, and may avoid multiple reduction operations caused by the appearance of same slot in a plurality of sliding time windows.

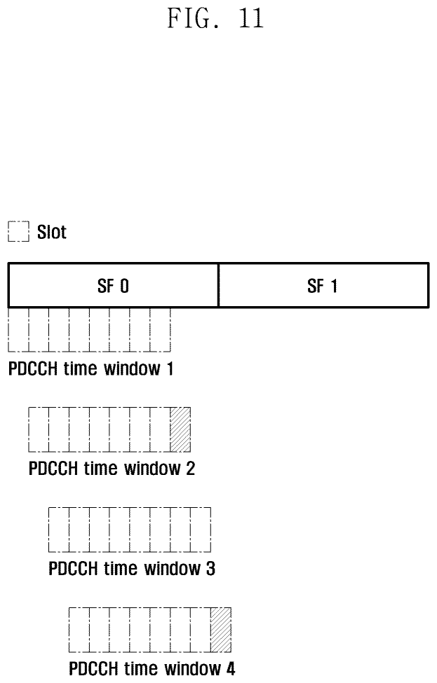

FIG. 11 illustrates an example of a search space of a UE according to various embodiments of the present disclosure. As illustrated in FIG. 11, the sliding time window 1 contains slots 1-8, and the times of blind detection (BD) for PDCCH/the number of non-overlapping control channel elements (CCE) to be detected in the sliding time window does not exceed the maximum value. The sliding time window 2 contains slots 2-9, and the times of blind detection (BD) for PDCCH/the number of non-overlapping control channel elements (CCE) to be detected in the sliding time window exceeds the maximum value, then the UE may reduce the times of blind detection (BD) for PDCCH/the number of non-overlapping control channel elements (CCE) in the last slot, so that the sum of the times of blind detection (BD) for PDCCH/the number of non-overlapping control channel elements (CCE) to be detected in all slots within the sliding time window does not exceed the maximum value.

In another example of (2), if the PDCCH SS configured by the base station causes the times of blind detection (BD) for PDCCH/the number of non-overlapping control channel elements (CCE) to be processed by the UE within one sliding time window exceed the UE's maximum number of the times of blind detection (BD) for PDCCH/number of non-overlapping control channel elements (CCE), the UE reduces the times of blind detection (BD) for PDCCH/the number of non-overlapping control channel elements (CCE) in the PDCCH SS in the first MO slots in the current sliding time window until the times of blind detection (BD) for PDCCH/the number of non-overlapping control channel elements (CCE) to be processed does not exceed UE's maximum number of the times of blind detection for PDCCH/number of non-overlapping control channel elements (CCE), where M1≥1. In this way, the impact on the detection for the PDCCH of the slot which is later in terms of time can be reduced.

In yet another example of (3), if the PDCCH SS configured by the base station causes the times of blind detection (BD) for PDCCH/the number of non-overlapping control channel elements (CCE) to be processed by the UE within one sliding time window exceed the UE's maximum number of the times of blind detection (BD) for PDCCH/number of non-overlapping control channel elements (CCE), the UE reduces the times of blind detection (BD) for PDCCH/the number of non-overlapping control channel elements (CCE) in the PDCCH SS in the last M2 slots in the preceding sliding time window until the times of blind detection (BD) for PDCCH/the number of non-overlapping control channel elements (CCE) to be processed in the current sliding time window does not exceed UE's maximum number of the times of blind detection for PDCCH/number of non-overlapping control channel elements (CCE).

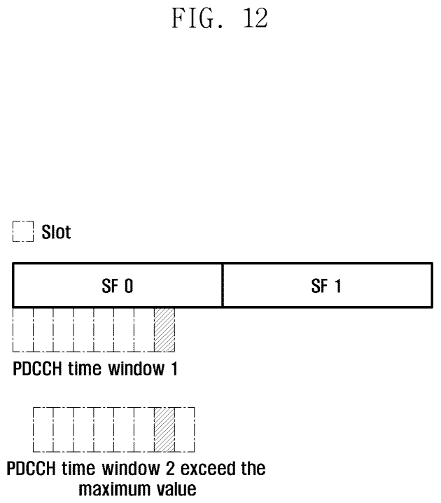

FIG. 12 illustrates an example of a search space of a UE according to various embodiments of the present disclosure. As illustrated in FIG. 12, it is assumed that the times of blind detection (BD) for PDCCH/the number of non-overlapping control channel elements (CCE) to be processed within the PDCCH sliding time window 1 does not exceed the maximum value, but the times of blind detection (BD) for PDCCH/the number of non-overlapping control channel elements (CCE) to be processed within the PDCCH sliding time window 2 exceeds the maximum value. The UE reduces the times of blind detection (BD) for PDCCH/the number of non-overlapping control channel elements (CCE) of the last slot within sliding time window 1, so that the total number in sliding time window 2 does not exceed the maximum value. In this way, the impact on the detection for the PDCCH of the slot which is later in terms of time can be reduced.

In yet another example of (4), if the PDCCH SS configured by the base station causes the times of blind detection (BD) for PDCCH/the number of non-overlapping control channel elements (CCE) to be processed by the UE within one sliding time window exceed the UE's maximum number of the times of blind detection (BD) for PDCCH/number of non-overlapping control channel elements (CCE), the UE reduces the times of blind detection (BD) for PDCCH/the number of non-overlapping control channel elements (CCE) in the PDCCH SS with lower priority in the preceding sliding time window until the times of blind detection (BD) for PDCCH/the number of non-overlapping control channel elements (CCE) to be processed in the current sliding time window does not exceed UE's maximum number of the times of blind detection for PDCCH/number of non-overlapping control channel elements (CCE).

In yet another example of (5), if the PDCCH SS configured by the base station causes the times of blind detection (BD) for PDCCH/the number of non-overlapping control channel elements (CCE) to be processed by the UE within one sliding time window exceed the UE's maximum number of the times of blind detection (BD) for PDCCH/number of non-overlapping control channel elements (CCE), the UE determines the priority of SS according to the type of PDCCH SS and the index of SS, reduces the times of blind detection (BD) for PDCCH/the number of non-overlapping control channel elements (CCE) in the SS with lower priority within the current sliding time window, until the times of blind detection (BD) for PDCCH/the number of non-overlapping control channel elements (CCE) to be processed by the UE in the sliding time window does not exceed UE's maximum number of the times of blind detection for PDCCH/number of non-overlapping control channel elements (CCE). When the SSs with the same priority are located at a plurality of time positions, for example, located in a plurality: of slots, the PDCCH may be adjusted one by one according to the time position, for example, the PDCCH which is later in terms of time is preferentially adjusted.

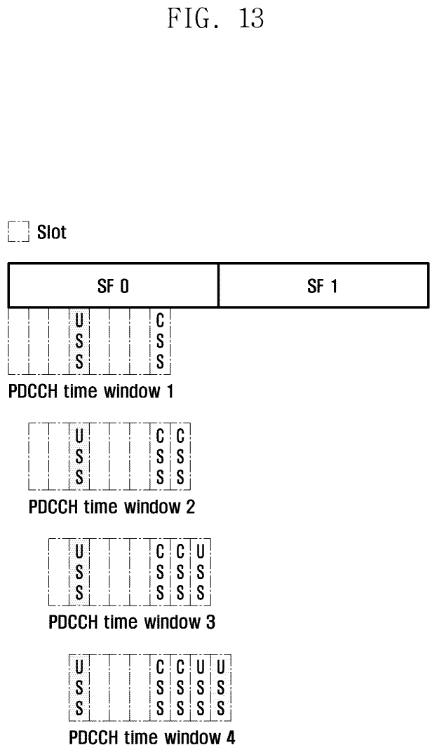

FIG. 13 illustrates an example of a search space of a UE according to various embodiments of the present disclosure. As illustrated in FIG. 13, it is assumed that slot 4 contains USS 1, slots 8 and 9 contain CSS, slot 10 contains USS 0, and slot 11 contains USS 1. It is assumed that the times of blind detection (BD) for PDCCH/the number of non-overlapping control channel elements (CCE) to be processed within the PDCCH sliding time window 1 does not exceed the maximum value, but the times of blind detection (BD) for PDCCH/the number of non-overlapping control channel elements (CCE) to be processed within the PDCCH sliding time window 2 exceeds the maximum value. The UE reduces the PDCCH of SS with low priority in time window 2, that is, the PDCCH of USS1, so that the total number in time window 2 does not exceed the maximum value.

It is assumed that the times of blind detection (BD) for PDCCH/the number of non-overlapping control channel elements (CCE) to be processed within the PDCCH sliding time window 3 does not exceed the maximum value, and the times of blind detection (BD) for PDCCH/the number of non-overlapping control channel elements (CCE) to be processed within the PDCCH sliding time window 4 exceeds the maximum value, then the PDCCHs of SSs with lower priority among all the SSs within sliding time window 4 may be adjusted. Since USSs 1 in slot 4 and slot 11 are of the lowest priority, the PDCCHs of these two slots are adjusted, so that times of blind detection (BD) for PDCCH/the number of non-overlapping control channel elements (CCE) to be processed within the PDCCH sliding time window 4 does not exceed the maximum value.

Since the SSs of the same SS type may be located in a plurality of slots, and the priority order of the same SS type differs in different time windows, in this way, the detection for PDCCH may be adjusted a plurality of times in the same slot due to the impact imposed by a plurality of time windows. However, this has the advantage that it may minimize the impact on SSs with higher priority and process all time windows in the same way.

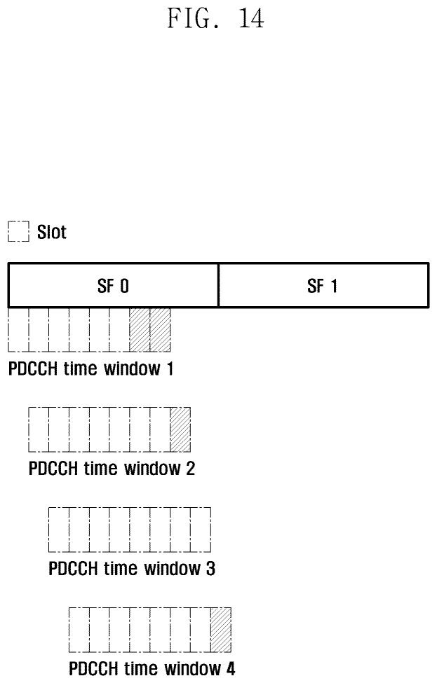

In yet another example of (5), if a sliding time window contains slots that only appear once in one time window (it is not difficult to see that the sliding time window is the first sliding time window after a period N, such as the first time window of SF0 or SF1024 in FIG. 11), and the times of blind detection (BD) for PDCCH/the number of non-overlapping control channel elements (CCE) to be processed by the UE within one sliding time window exceed the UE's maximum number of the times of blind detection (BD) for PDCCH/number of non-overlapping control channel elements (CCE), UE reduces the times of blind detection (BD) for PDCCH/the number of non-overlapping control channel elements (CCE) in the PDCCH SS in the last M2 slots in the one sliding time window, so that the times of blind detection (BD) for PDCCH/the number of non-overlapping control channel elements (CCE) to be processed by the UE in the time window does not exceed UE's maximum number of the times of blind detection for PDCCH/number of non-overlapping control channel elements (CCE). The value of M2 may be different from M1, and the value of M2 is determined by the reduced times of blind detection (BD) for PDCCH/the number of non-overlapping control channel elements (CCE). FIG. 14 illustrates an example of a search space of a UE. For example, as illustrated in FIGS. 14, M2=2, and M1=1.

Preferably, M2=M1. When configuring SS, the base station may determine that the times of blind detection for PDCCH/number of non-overlapping control channel elements (CCE) to be detected within the sliding time window does not exceed the maximum value, after the UE reduces the times of blind detection for PDCCH/number of non-overlapping control channel elements (CCE) in the last M2 slots of the sliding time window.

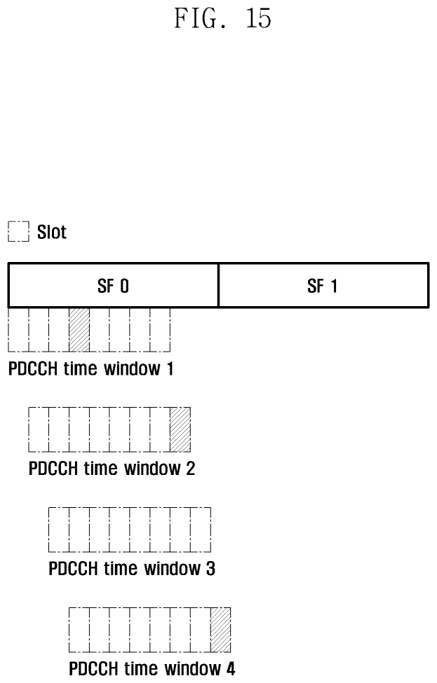

In yet another example of (6), if a sliding time window contains slots that only appear once in one time window (it is not difficult to see that the sliding time window is the first sliding time window after a period N, such as the first time window of SF0 or SF1024 in FIG. 11), and the times of blind detection (BD) for PDCCH/the number of non-overlapping control channel elements (CCE) to be processed by the UE within one sliding time window exceed the UE's maximum number of the times of blind detection (BD) for PDCCH/number of non-overlapping control channel elements (CCE), the UE determines the priority of SS according to the type of PDCCH SS and the index of SS, reduces the times of blind detection (BD) for PDCCH/the number of non-overlapping control channel elements (CCE) in the SS with lower priority within the one time window, so that the times of blind detection (BD) for PDCCH/the number of non-overlapping control channel elements (CCE) to be processed by the UE in the sliding time window does not exceed UE's maximum number of the times of blind detection for PDCCH/number of non-overlapping control channel elements (CCE). FIG. 15 illustrates an example of a search space of a UE. For example, as illustrated in FIG. 15, it is assumed that USS is configured in slot 4 and CSS is configured in slot 8, thus, the times of blind detection (BD) for PDCCH/the number of non-overlapping control channel elements (CCE) in slot 4 are preferentially reduced.

To mitigate the burden of detecting PDCCH by the UE, for PDCCH or PDSCH of a specific type, the UE does not need to process a plurality of PDCCHs or PDSCHs of the same type in a relatively short period of time. For example, if the UE is configured with SS 0 of Type-0 CSS, SS for SIB1, SS for other system information, SS for paging, SS for random access, and at least one set of SSs in CSS configured by PDCCH-Config, and also, the UE is configured with at least one of SI-RNTI, P-RNTI, RA-RNTI, SFI-RNTI, INT-RNTI, TPC-PUSCH-RNTI, TPC-PUCCH-RNTI, and TPC-SRS-RNTI, the UE does not expect to process more than one DCI scrambled by the RNTI of same type within a predefined time window. The length of the predefined time window is X slots, or symbols, or slot groups. The value of X is predefined by standards or configured by the base station. The value of X is related to the subcarrier spacing.

Preferably, when configuring SS, the base station may satisfy that: Type-1 CSS that are not configured based on dedicated RRC signaling as well as Type-0 CSS, Type-0 CSS and Type-2 CSS only appear in one sub-time window within one time window, wherein the length of the sub-time window is L. In the time window, one type of CSS among these CSSs only appears at most once within the time window, and in a sub-time window which consists of L continuous symbols. Preferably, the sub-time window may be at any position within the time window. Preferably, the sub-time window is at a specific position within the time window, for example, the starting point of the sub-time window is within the first Li symbols of the time window.

According to one implementation, if there are at least two types of CSS among these CSSs within the time window, the at least two types of CSS are located within the same sub-time window. According to another implementation, if there are at least two types of CSS among these CSSs in the time window, the at least two types of CSS may be located in two sub-time windows respectively, and the two sub-time windows may not completely overlap.

According to one implementation, the number of PDCCH MO of SS 0 of Type-0 CSS within a predefined time window length is controlled through the configuration of time resources of SS. For example, the time resources of PDCCH MOs corresponding to the same SS/PBCH index i are respectively located in slot n0 and slot n0+X, wherein X is the length of time window, and n0 is determined according to index i, subcarrier spacing, the number of PDCCH MOs contained in a slot, and the number of slots within one frame. Preferably, n0 is also determined by the time window length X.

To reduce the complexity of PDCCH detection of UE within a predefined time window, the time resource information of the SS configured by the base station includes at least one of the following: period of SS and the time offset of SS, the number M of consecutive time windows within one period, the length of the time window, the number L of slots in each time window, and the number Z of symbols in each slot. Wherein the length of the time window is predefined by standards or configured by the base station. The M time windows are the 1st to Mth time windows starting from one period. The base station configures the starting point and length, or the starting point and the ending point of L consecutive slots within one time window, or the default starting point is the first slot and the default length is consecutive L slots in the time window. The base station configures Z symbols within one slot, and the Z symbols are continuous or discrete. For example, the base station configures SS with: a period length of 80 slots, an offset of 0 slots, M=3 time windows, a time window length of 8 slots, and L=2 slots starting from the first slot in each time window. In each slot, the 1st to 3rd symbols are the time resources of SS. Thus, the time resources of PDCCH MO of the SS are the 1st to 3rd slots among slots 0, 1, 8, 9, 16, 17, slots 80, 81, 88, 89, 96, 97. . . .

Although the various embodiments of the present application are mainly described from the UE side, those skilled in the art will understand that the various embodiments of the present application also include operations on the base station side, and the base station side may perform operations corresponding to those on the UE side.

Those skilled in the art will understand that the various illustrative logical blocks, modules, circuits, and steps described in this application can be implemented as hardware, software, or a combination of hardware and software. In order to clearly illustrate the interchangeability of hardware and software, various illustrative components, blocks, modules, circuits, and steps are generally described above in the form of their function sets. Whether such function sets are implemented as hardware or software depends on the specific application and design constraints imposed on the overall system. Those skilled in the art can implement the described function set in different ways for each specific application, but such design decisions should not be construed as causing a departure from the scope of this application.

The various illustrative logic blocks, modules, and circuits described in this application may be implemented or executed by general-purpose processors, digital signal processors (DSP), application-specific integrated circuits (ASIC), field programmable gate arrays (FPGA) or other programmable logic devices, discrete gate or transistor logic, discrete hardware components, or any combination designed to perform the functions described herein. A general-purpose processor may be a microprocessor, but in the alternative embodiment, the processor may be any conventional processor, controller, microcontroller, or state machine. The processor may also be implemented as a combination of computing devices, for example, a combination of a DSP and a microprocessor, multiple microprocessors, one or more microprocessors in cooperation with a DSP core, or any other such configuration.

The steps of the method or algorithm described in this application can be directly embodied in hardware, in a software module executed by a processor, or in a combination of the hardware and software module. The software module may reside in RAM memory, flash memory, ROM memory, EPROM memory, EEPROM memory, registers, hard disk, removable disk, or any other form of storage medium known in the art. An exemplary storage medium is coupled to the processor such that the processor can read information from/write information to the storage medium. In the alternative embodiment, the storage medium may be integrated into the processor. The processor and the storage medium may reside in the ASIC. The ASIC may reside in the user terminal. In the alternative embodiment, the processor and the storage medium may reside as discrete components in the user terminal.

In one or more exemplary designs, the said functions may be implemented in hardware, software, firmware, or any combination thereof. If implemented in software, each function can be stored on a computer-readable medium or transmitted over a computer-readable medium as one or more instructions or codes. Computer-readable media includes both computer storage media and communication media, the latter including any media that facilitates the transfer of a computer program from one place to another. The storage medium may be any available medium that can be accessed by a general-purpose or special-purpose computer.

The embodiments of this application are only intended for ease of description and to help comprehensive understanding of this application, and are not intended to limit the scope of this application. Therefore, it should be understood that, except for the embodiments disclosed herein, all modifications and changes or forms of modifications and changes derived from the technical idea of the present application fall within the scope of the present application.

The above are only the preferred embodiments of the present disclosure and are not intended to limit the present disclosure. Any modification, equivalent replacement, improvement, etc. made within the spirit and principle of the present disclosure shall be included within the scope of protection of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a base station, configuration of search space with index zero associated with Type0-physical downlink control channel (PDCCH) common search space (CSS) set; and
identifying PDCCH monitoring occasions for the Type0-PDCCH CSS set based on information, wherein the PDCCH monitoring occasions are in slot n₀ and slot n₀+k,
wherein the slot n₀ depends on a synchronization signal and physical broadcast channel (SS/PBCH) block index associated with the information, and
wherein a value of k is related to a subcarrier spacing.

2. The method of claim 1, further comprising:
receiving, from the base station, time resource information for a search space; and
identifying time resources for a first search space set based on the time resource information, wherein the time resources for the first search space set satisfies a constraint associated with a combination (X, Y) indicated by the UE as a capability where X and Y are number of consecutive slots,
wherein the first search space set corresponds to at least one of:
a Type1-PDCCH CSS set configured by dedicated radio resource control (RRC) signaling;
a Type3-PDCCH CSS set; or
a USS set.

3. The method of claim 1, further comprising:
receiving, from the base station, time resource information for a search space; and
identifying time resources within a time window for a second search space set based on the time resource information, wherein the time window comprises a group of slots and the time resources for the second search space set satisfies a constraint associated with the time window,
wherein the second search space set corresponds to at least one of:
the Type0-PDCCH CSS set;
a Type0A-PDCCH CSS set; or
a Type2-PDCCH CSS set.

4. The method of claim 1, further comprising:
receiving, from the base station, time resource information for a search space; and
identifying time resources within a time window for a third search space set based on the time resource information, wherein the time window comprises a group of slots and the time resources for the third search space set is in one sub-time window within the time window,
wherein the third search space set corresponds to Type-1 PDCCH CSS set configured by PDCCH-Configcommon.

5. A method performed by a base station in a communication system, the base station comprising:
transmitting, to a user equipment (UE), configuration of search space with index zero associated with Type0-physical downlink control channel (PDCCH) common search space (CSS) set,
wherein PDCCH monitoring occasions for the Type0-PDCCH CSS set is based on information, wherein the PDCCH monitoring occasions are in slot n₀ and slot n₀+k,
wherein the slot n₀ depends on a synchronization signal and physical broadcast channel (SS/PBCH) block index associated with the information, and
wherein a value of k is related to a subcarrier spacing.

6. The method of claim 5, further comprising:
transmitting, to the UE, time resource information for a search space,
wherein time resources for a first search space set is based on the time resource information,
wherein the time resources for the first search space set satisfies a constraint associated with a combination (X, Y) indicated by the UE as a capability, where X and Y are number of consecutive slots, and
wherein the first search space set corresponds to at least one of:
a Type1-PDCCH CSS set configured by dedicated radio resource control (RRC) signaling;
a Type3-PDCCH CSS set; or
a USS set.

7. The method of claim 5, further comprising:
transmitting, to the UE, time resource information for a search space,
wherein time resources within a time window for a second search space set is based on the time resource information,
wherein the time window comprises a group of slots and the time resources for the second search space set satisfies a constraint associated with the time window, and
wherein the second search space set corresponds to at least one of:
the Type0-PDCCH CSS set;
a Type0A-PDCCH CSS set; or
a Type2-PDCCH CSS set.

8. The method of claim 5, further comprising:
transmitting, to the UE, time resource information for a search space,
wherein time resources within a time window for a third search space set is based on the time resource information,
wherein the time window comprises a group of slots and the time resources for the third search space set is in one sub-time window within the time window, and
wherein the third search space set corresponds to Type-1 PDCCH CSS set configured by PDCCH-Configcommon.

9. A user equipment (UE) in a communication system, the UE comprising:
a transceiver; and
at least one processor configured to:
receive, from a base station, configuration of search space with index zero associated with Type0-physical downlink control channel (PDCCH) common search space (CSS) set, and
identify PDCCH monitoring occasions for the Type0-PDCCH CSS set based on information, wherein the PDCCH monitoring occasions are in slot n₀ and slot n₀+k,
wherein the slot n₀ depends on a synchronization signal and physical broadcast channel (SS/PBCH) block index associated with the information, and
wherein a value of k is related to a subcarrier spacing.

10. The UE of claim 9, wherein the at least one processor is further configured to:
receive, from the base station, time resource information for a search space; and
identify time resources for a first search space set based on the time resource information, wherein the time resources for the first search space set satisfies a constraint associated with a combination (X, Y) indicated by the UE as a capability, where X and Y are number of consecutive slots,
wherein the first search space set corresponds to at least one of:
a Type1-PDCCH CSS set configured by dedicated radio resource control (RRC) signaling;
a Type3-PDCCH CSS set; or
a USS set.

11. The UE of claim 9, wherein the at least one processor is further configured to:
receive, from the base station, time resource information for a search space; and
identify time resources within a time window for a second search space set based on the time resource information, wherein the time window comprises a group of slots and the time resources for the second search space set satisfies a constraint associated with the time window,
wherein the second search space set corresponds to at least one of:
the Type0-PDCCH CSS set;
a Type0A-PDCCH CSS set; or
a Type2-PDCCH CSS set.

12. The UE of claim 9, wherein the at least one processor is further configured to:
receive, from the base station, time resource information for a search space; and
identify time resources within a time window for a third search space set based on the time resource information, wherein the time window comprises a group of slots and the time resources for the third search space set is in one sub-time window within the time window,
wherein the third search space set corresponds to Type-1 PDCCH CSS set configured by PDCCH-Configcommon.

13. A base station in a communication system, the base station comprising:
a transceiver; and
at least one processor configured to:
transmit, to a user equipment (UE), configuration of search space with index zero associated with Type0-physical downlink control channel (PDCCH) common search space (CSS) set,
wherein PDCCH monitoring occasions for the Type0-PDCCH CSS set is based on information, wherein the PDCCH monitoring occasions are in slot n₀ and slot n₀+k,
wherein the slot n₀ depends on a synchronization signal and physical broadcast channel (SS/PBCH) block index associated with the information, and
wherein a value of k is related to a subcarrier spacing.

14. The base station of claim 13, wherein the at least one processor is further configured to:
transmit, to the UE, time resource information for a search space,
wherein time resources for a first search space set is based on the time resource information,
wherein the time resources for the first search space set satisfies a constraint associated with a combination (X, Y) indicated by the UE as a capability, where X and Y are number of consecutive slots, and
wherein the first search space set corresponds to at least one of:
a Type1-PDCCH CSS set configured by dedicated radio resource control (RRC) signaling;
a Type3-PDCCH CSS set; or
a USS set.

15. The base station of claim 13, wherein the at least one processor is further configured to:
transmit, to the UE, time resource information for a search space,
wherein time resources within a time window for a second search space set is based on the time resource information,
wherein the time window comprises a group of slots and the time resources for the second search space set satisfies a constraint associated with the time window, and
wherein the second search space set corresponds to at least one of:
the Type0-PDCCH CSS set;
a Type0A-PDCCH CSS set; or
a Type2-PDCCH CSS set.

16. The base station of claim 13, wherein the at least one processor is further configured to:
transmit, to the UE, time resource information for a search space,
wherein time resources within a time window for a third search space set is based on the time resource information,
wherein the time window comprises a group of slots and the time resources for the third search space set is in one sub-time window within the time window, and
wherein the third search space set corresponds to Type-1 PDCCH CSS set configured by PDCCH-Configcommon.
